(19) United States
(12) Patent Application Publication
(10) Pub. No.: US 2010/0226653 A1
(43) Pub. Date: Sep. 9, 2010

(54) CIRCUIT FOR SWITCHING SIGNAL PATH, ANTENNA MODULE AND RADIO OVER FIBER SYSTEM

(75) Inventors: Chien-Hung Yeh, Hsinchu County (TW); Chi-Wai Chow, FANLING (HK); Sien Chi, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/431,762

(22) Filed: Apr. 29, 2009

(30) Foreign Application Priority Data
Mar. 5, 2009 (TW) 98107139

(51) Int. Cl. H04B 10/00

(52) U.S. Cl. 398/115

(57) ABSTRACT

A circuit for switching a signal path includes a path selection element, a detector, a switch, and a control circuit. A first end and a third end of the path selection element are coupled to the detector and the switch, respectively. The switch is normally in a conductive status for outputting an upload signal through the path selection element and the switch when the upload signal is input from a second end of the path selection element. When a download signal is transmitted to the detector, the detector transmits the download signal to the path selection element and enables a detection signal. The control circuit switches the switch status to an open-circuit status for outputting the download signal isolated by the switch from the second end of the path selection element. Until the download signal is transmitted completely, the control circuit switches the switch status to the conductive status.

### CROSS-REFERENCE TO RELATED APPLICATION

This application claims the priority benefit of Taiwan application serial no. 98107139, filed on Mar. 5, 2009. The entirety of the above-mentioned patent application is hereby incorporated by reference herein and made a part of this specification.

### BACKGROUND OF THE INVENTION

1. Technical Field

The disclosure relates to a circuit for switching a signal path, antenna module and radio over fiber system.

2. Background

A communication transmission of a wireless access network is basically categorized to be in a time division duplex (TDD) mode and a frequency division duplex (FDD) mode. Among the two modes, the TDD mode is more common in the field of the communication transmission.

FIG. 1 is a block diagram of a conventional circuit for a TDD system in a wireless communication system. Referring to FIG. 1, the conventional TDD system 100 may receive an upload data signal UL_Data through an antenna 120, or transmit a download data signal DL_Data through the antenna 120 to a user. The TDD system 100 includes a switch 102, a low noise amplifier (LNA) 104, a power amplifier 106, and a control circuit 108. The switch 102 is a one-to-two switch. A first end of the switch 102 is coupled to the antenna 120, and a second end and a third end of the switch 102 are coupled to an input end of the LNA 104 and an output end of the power amplifier 106, respectively. In addition, the control circuit 108 may be coupled to an output end of the LNA 104 and an input end of the power amplifier 106, and may also be coupled to the switch 102.

In a normal situation, the switch 102 conducts the first end of the switch 102 to the second end of the switch 102. Thus, when the antenna 120 receives the upload data signal UL_Data, the upload data signal UL_Data may then be transmitted to the LNA 104 through a conducted path. After the upload data signal UL_Data passes through the LNA 104, the upload data signal UL_Data may be transmitted to the control circuit 108 and then output by the control circuit 108. On the contrary, when the control circuit 108 receives the download data signal DL_Data, the control circuit 108 may also transmit the download data signal DL_Data to the power amplifier 106 and transmit the download data signal DL_Data to the switch 102 through the power amplifier 106. At this time, due to the fact that the switch 102 may conduct the first end of the switch 102 to the third end of the switch 102, the download data signal DL_Data may be transmitted to the antenna 120 through the conducted path and then transmitted to the user through the antenna 120. When the control circuit 108 detects that the download data signal DL_Data is transmitted completely, the control circuit 108 may control the switch 120 to switch the first end of the switch 120 back to be conductive to the second end of the switch 120.

A signal isolation capability of the conventional switch 102 is between around 40-50 decibels (dB) for preventing the download data signal DL_Data with high power from passing through the switch 102 and then damaging the LNA 104 (the signal isolation capability of normal LNAs is between around 25-30 dB). However, when the download data signal DL_Data has power greater than 30 dBm, signals may possibly pass through the conventional switch 102 and damage the LNA 104. Therefore, a circuit for switching a signal path in the wireless communication system becomes an important issue to be researched and discussed.

### SUMMARY

Accordingly, the present application provides a circuit for switching a signal path in a time division multiplexing system.

Consistent with the invention, there is provided a circuit for switching a signal path adapted for a time division multiplexing system is provided. The circuit for switching the signal path includes a path selection element, a detector, a switch, and a control circuit. A first end and a third end of the path selection element are coupled to the detector and the switch, respectively. When a status of the switch is conductive, after an upload data signal is input from a second end of the path selection element, the upload data signal may be transmitted to the switch from the third end and output from the switch. When a download data signal is transmitted to the detector, the detector may transmit the download data signal to a first end of the path selection element and enable a detection signal. At this time, the control circuit may control the switch to be in an open-circuit status, and the download data signal is output from the second end of the path selection element. Until the download data signal is transmitted completely, the detector disables the detection signal so as to control the status of the switch to be conductive.

Also consistent with the invention, there is provided an exemplary antenna module. The antenna module may be adapted to a radio over fiber system. The antenna module includes a transceiver antenna, a path selection element, a detector, a switch, and a control circuit. The transceiver antenna may be coupled to a second end of the path selection element, and a first end and a third end of the path selection element may be coupled to the detector and the switch, respectively. When a status of the switch is conductive, after the transceiver antenna receives an upload data signal, the upload data signal may be input from a second end of the path selection element, transmitted to the switch from the third end, and output from the switch. When a download data signal is transmitted to the detector, the detector may transmit the download data signal to the first end of the path selection element and transmit the download data signal to the transceiver antenna from the second end. Besides, the detector may enable a detection signal. At this time, the control circuit may control the switch to be in an open-circuit status, and the download data signal is output from the second end of the path selection element. Until the download data signal is transmitted completely, the detector disables the detection signal so as to control the status of the switch back to be conductive.

Further, and consistent with the invention, there is provided an exemplary radio over fiber system. The radio over fiber system includes a switching center, a head-end cell unit, and a remote antenna end cell unit. The head-end cell unit may be coupled to the switching center and the remote antenna end cell unit, respectively. The remote antenna end cell unit may transmit an upload data signal to the switching center through the head-end cell unit or receive a download data signal from the switching center through the head-end cell unit. The remote antenna end cell includes a transceiver antenna, a path selection element, a detector, a switch, and a control circuit. The transceiver antenna may be coupled to a second end of the path selection element, and a first end and a third end of the path selection element may be coupled to the detector and the switch, respectively. When a status of the switch is conductive, after the transceiver antenna receives the upload data signal, the upload data signal may be input from a second end of the path selection element, transmitted to the switch from the third end, and output from the switch. When the download data signal is transmitted to the detector, the detector may transmit the download data signal to the first end of the path selection element and transmit the download data signal to the transceiver antenna from the second end. Besides, the detector may enable a detection signal. At this time, the control circuit may control the switch to be in an open-circuit status, and the download data signal is output from the second end of the path selection element. Until the download data signal is transmitted completely, the detector disables the detection signal so as to control the status of the switch back to be conductive.

It is to be understood that both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the invention and incorporated in and constitute a part of this specification. The drawings illustrate embodiments of the invention and, together with the description, serve to explain the principles of the invention.

FIG. 1 is a block diagram of a conventional circuit for a TDD system in a wireless communication system.

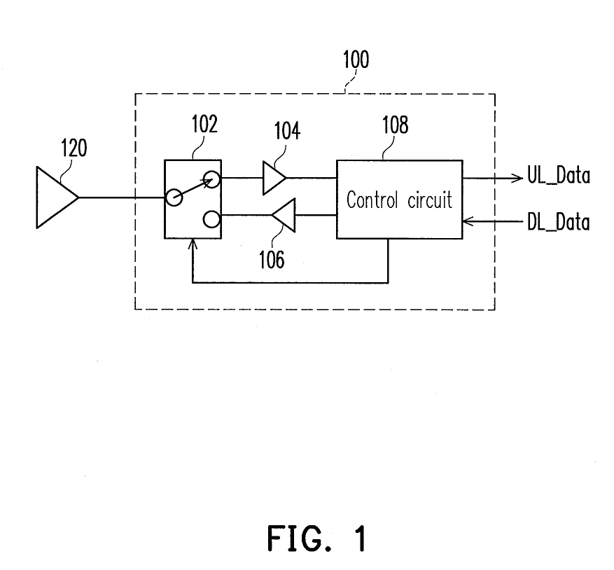

FIG. 2 is a system block diagram of a radio over fiber system according to an exemplary embodiment consistent with the present invention.

FIG. 3 is a system block diagram of an antenna module according to an exemplary embodiment consistent with the present invention.

FIG. 4 is a block diagram of a circuit for switching a signal path according to an exemplary embodiment consistent with the present invention.

### DESCRIPTION OF EMBODIMENTS

Reference will now be made in detail to an exemplary embodiment consistent with the present embodiments of the invention, examples of which are illustrated in the accompanying drawings. Wherever possible, the same reference numbers are used in the drawings and the description to refer to the same or like parts.

In exemplary embodiments consistent with the present invention, there is provided a circuit for switching a signal path for executing a time division multiplexing operation is provided.

In exemplary embodiments consistent with the present invention, there is provided an antenna module adapted for a radio over fiber system and also for protecting an amplifier from being damaged by a data signal with excessively high power is also provided.

In exemplary embodiments consistent with the present invention, there is provided a radio over fiber system having a high signal isolation capability for processing the data signal with high power is also provided.

In exemplary embodiments consistent with the present invention, there is provided a path selection element and a switch is allocated in order to ensure a multi-level protection. Thus, a download data signal with high power is efficiently isolated to prevent the amplifier from being damaged.

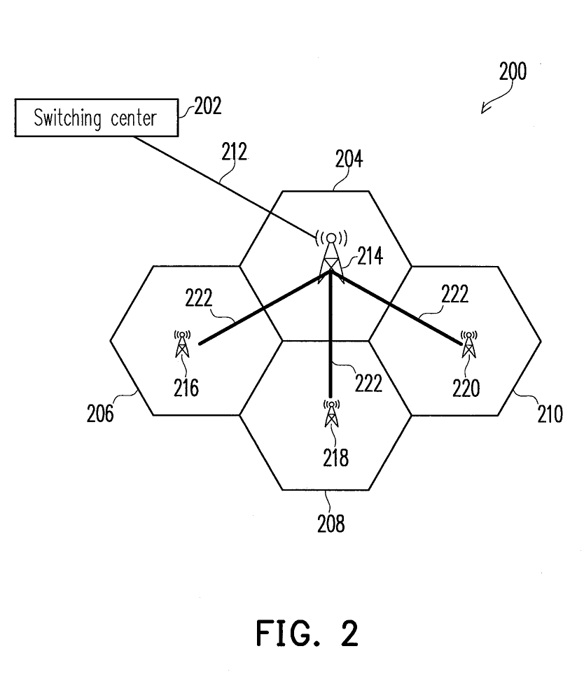

FIG. 2 is a system block diagram of a radio over fiber (ROF) system according to an exemplary embodiment consistent with the present invention. Referring to FIG. 2, the embodiment consistent with the invention provides an ROF system 200 which includes a switching center 202, a head-end cell unit 204, a remote antenna end cell unit 206, a remote antenna end cell unit 208, and a remote antenna end cell unit 210. The head-end cell unit 204 includes a head-end base station 214 and is coupled to the switching center 202 through a transmission interface 212, such as an optical fiber, a coaxial cable, and so on.

On the other hand, each of the remote antenna end cell unit 206, the remote antenna end cell unit 208, and the remote antenna end cell unit 210, for example, remote antenna unit (RAU) is coupled to an antenna end base station 216, an antenna end base station 218, and an antenna end base station 220 respectively and correspondingly. In the present embodiment, each of the antenna end base station 216, the antenna end base station 218, and the antenna end base station 220 may be coupled to the head-end base station 214 located in the head-end cell unit 204 through an optical fiber 222.

Each of the remote antenna end cell unit 206, the remote antenna end cell unit 208, and the remote antenna end cell unit 210 has its signal reception coverage area, and thus together forms a cellular structure. When a user utilizes wireless communication equipment, for example, a mobile phone, and wants to upload an upload data signal, the upload data signal may be processed by the remote antenna end cell unit whose signal reception area covers a current location of the user. For example, when the user is located within a communication area covered by the remote antenna end cell unit 206, the antenna end base station 216 receives the upload data signal, converts the upload data signal to an optical signal, and further transmits the converted upload data signal in an optical form to the head-end base station 214 through the optical fiber 222. Accordingly, the head-end base station 214 may transmit the upload data signal of the user to the switching center 202 through the transmission interface 212.

On the other hand, a download data signal can be transmitted to the user through a transmission path opposite to the above-mentioned transmission path, and thus detailed descriptions will not be again provided herein. In some embodiments consistent with the invention, the switching center 212 may also be connected with the Internet. Thus, the user can be connected with the Internet through the ROF system 300 at any time and at any location.

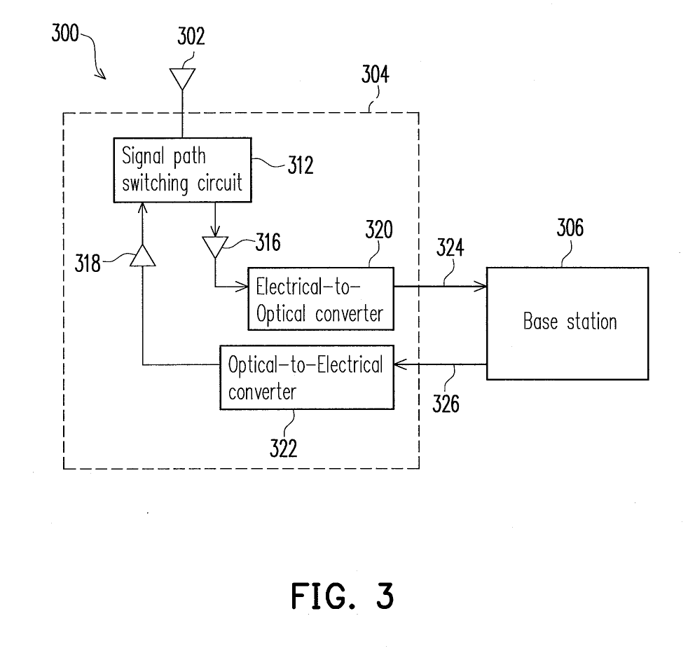

FIG. 3 is a system block diagram of an antenna module according to one exemplary embodiment consistent with the present invention, wherein the antenna module can be adapted to the antenna end base station 216, the antenna end base station 218, and the antenna end base station 220 as illustrated in FIG. 2. Referring to FIG. 3, the antenna module 300 provided by the present embodiment includes a transceiver antenna 302 and a TDD system 304. Besides, the TDD system 304 can be coupled to the transceiver antenna 302 and a corresponding base station 306.

The TDD system 304 includes a signal path switching circuit 312, an LNA 316, a power amplifier 318, an electrical-to-optical converter 320, and an optical-to-electrical converter 322. The signal path switching circuit 312 can be coupled to the transceiver antenna 302, an input end of the LNA 316, and an output end of the power amplifier 318, respectively. Besides, an output end of the LNA 316 may be coupled to the base station 306 through the electrical-to-optical converter 320, and the base station 306 may be coupled to an input end of the power amplifier 318 through the optical-to-electrical converter 322. In the present embodiment, the electrical-to-optical converter 320 and the optical-to-electrical converter 322 may be coupled to the base station 306 through an optical fiber 324 and an optical fiber 326, respectively.

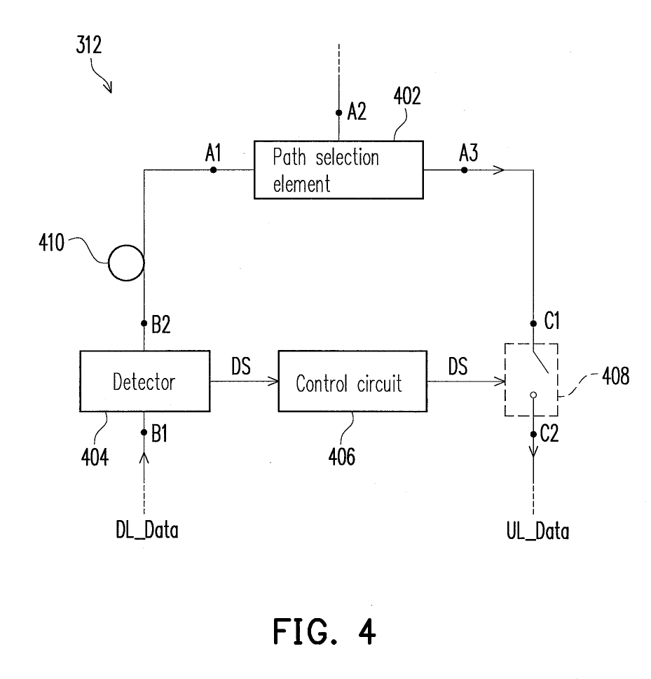

FIG. 4 is a circuit block diagram of a circuit for switching a signal path according to one exemplary embodiment consistent with the present invention. Referring to FIG. 4, the signal path switching circuit 312 provided by the present embodiment is adapted for a time division multiplexing system, and the signal path switching circuit 312 includes a path selection element 402, a detector 404, a control circuit 406, and a switch 408. In the present embodiment, the signal path switching circuit 312 further includes a delay element 410 which is, for example, a delay optical fiber. The path selection element 402 is, for example, a circulator or an optical coupler, and the path selection element 402 includes a first end A1, a second end A2, and a third end A3. Here, the second end A2 of the path selection element 402 may be coupled to the antenna 302 illustrated in FIG. 3, and the first end A1 and the third end A3 may be coupled to a detection output end B2 of the detector 404 and an upload input end C1 of the switch 408, respectively. In addition, the delay optical fiber 410 may be allocated on a path between the path selection element 402 and the detector 404.

Furthermore, a detection input end B 1 of the detector 404 may be coupled to, for example, the output end of the power amplifier 318 illustrated in FIG. 3, and the detector 404 may also be coupled to the control circuit 406. The control circuit 406 may be coupled to the switch 408. In addition, an upload output end C2 of the switch 408 may be coupled to an input end of the LNA 316 illustrated in FIG. 3.

Referring to both FIG. 3 and FIG. 4, when a signal is transmitted in the path selection element 402, the signal is directional. For example, after the signal is input from the first end A1 to the path selection element 402, the signal is guided by the path selection element 402 and is output from the second end A2; however, since the signal is affected by a signal isolation capability of the path selection element 402, the signal is not output from the third end A3. On the other hand, when the signal is input from the second end A2 into the path selection element 402, the signal is output from the third end A3.

It can be known from the above that when an upload data signal UL_Data is transmitted to the transceiver antenna 302 through a wireless transmission path, the upload data signal UL_Data is further transmitted to the TDD system 304. At this time, the upload data signal UL_Data may be input into the path selection element 402 from the second end A2 and further transmitted to the switch 408 through the third end A3. In normal situations, the switch 408 is in a conductive status. Thus, the upload data signal UL_Data may be transmitted to the input end of the LNA 316 through the switch 408. [0031] After the upload data signal UL_Data is transmitted to the LNA 316, the upload data signal UL_Data is amplified and then further transmitted to the electrical-to-optical converter 320 from the output end of the LNA 316. At this time, the electrical-to-optical converter 320 may convert the upload data signal UL_Data in an electrical from to be in an optical from, and the converted upload data signal UL_Data is further transmitted to the base station 306 through the optical fiber 324.

Furthermore, if the base station 306 receives a download data signal DL_Data, the received download data signal DL_Data is transmitted to the optical-to-electrical converter 322 through the optical fiber 326. Accordingly, the optical-to-electrical converter 322 may convert the download data signal DL_Data in an optical form to be in an electrical form, and may further transmit the download data signal DL_Data to the detection input end B1 of the detector 404 from the output end.

When the detector 404 detects that the detection input end B1 transmits the download data signal DL_Data to the delay optical fiber 410, the download data signal DL_Data is delayed for a preset time and then transmitted to the first end A1 of the path selection element 402. Accordingly, the download data signal DL_Data may be transmitted to the transceiver antenna 302 from the second end A2 of the path selection element 402 in order to be transmitted to the user through the above-mentioned wireless transmission path. On the other hand, when the detector 404 receives the download data signal DL_Data, the detector 404 may also enable a detection signal DS. At this time, the control circuit 406 may switch the status of the switch 408 to an open-circuit status in accordance with a status of the detection signal DS, such that the switch 408 can isolate the signal transmitted from the third end A3 of the path selection element 402.

In the present embodiment, in order to ensure the download data signal DL_Data against passing through the path selection element 402 and the switch 408 and further damaging the LNA 316, the delay time of the delay optical fiber 410 discussed above is required to be greater than a time required by the detector 404 for detecting the download data signal DL_Data plus a time required by the control circuit 406 for switching the switch 408 to be in the open-circuit status.

Next, after the detector 404 confirms that the download data signal DL_Data is transmitted completely, the detector 404 disables the detection signal DS. At this time, the control circuit 406 switches the status of the switch 408 back to the conductive status in accordance with the status of the detection signal DS. Similarly, in order to ensure that there lacks any residual portion of the download data signal DL_Data passing through the path selection element 402 and further reaching the switch 408, after the detection signal DS is disabled by the control circuit 406, the control circuit 406 is required to wait for a preset waiting time before switching the status of the switch 408 back to the conductive status.

In summary, the circuit for switching the signal path provided in the present application is equipped with a path selection element and a switch and provides a multi-level protection to prevent a download data signal with high power from damaging a power amplifier.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A circuit for switching a signal path adapted for a time division multiplexing system, wherein the circuit for switching the signal path comprises:
a path selection element comprising a first signal end, a second signal end, and a third signal end;
a detector comprising a detection input end and a detection output end, wherein the detection output end is coupled to the first signal end of the path selection element, and when the detector detects that the detection input end receives a download data signal, a detection signal is activated, the download data signal is transmitted from the download output end to the first signal end of the path selection element, and the download data signal is guided to the second signal end of the path selection element for outputting;
a switch comprising an upload input end and an upload output end, wherein the upload input end is coupled to the third signal end of the path selection element, an upload data signal is guided by the path selection element to be output from the third signal end to the switch when the upload data signal is input from the second signal end to the path selection element, and the upload data signal is output from the upload output end when the switch is in a conductive status; and
a control circuit coupled to the detector for controlling the switch to be in an open-circuit status when the detection signal is enabled and controlling the switch to be in the conductive status when the detection signal is disabled.

2. The circuit for switching the signal path as claimed in claim 1, further comprising a delay element allocated in a transmission path between the detector and the path selection element for delaying the download data signal output by the detector for a delay time and further inputting the download data signal from the first signal end to the path selection element.

3. The circuit for switching the signal path as claimed in claim 2, wherein the delay element is a delay optical fiber.

4. The circuit for switching the signal path as claimed in claim 3, wherein the delay time of the delay optical fiber is greater than a time required for detecting the download data signal by the detector plus a time required by the control circuit for switching the switch to be in the open-circuit status.

5. The circuit for switching the signal path as claimed in claim 1, wherein the path selection element is a circulator or an optical coupler.

6. The circuit for switching the signal path as claimed in claim 1, wherein the control circuit further waits for a preset time before changing the switch back to be in the conductive status when the detection signal is enabled.

7. The circuit for switching the signal path as claimed in claim 1, wherein the switch is normally conductive so as to enable the upload data signal to be transmitted through the switch.

8. An antenna module adapted for a base station of a remote antenna unit of a radio over fiber system, wherein the antenna module comprises:
a transceiver antenna transmitting a download data signal through a wireless transmission path or receiving an upload data signal;
a path selection element comprising a first signal end, a second signal end, and a third signal end, wherein the second signal end is coupled to the transceiver antenna;
a detector comprising a detection input end and a detection output end, wherein the detection output end is coupled to the first signal end of the path selection element, and when the detector detects that the detection input end receives the download data signal, a detection signal is activated, the download data signal is transmitted from the download output end to the first signal end of the path selection element, and the download data signal is guided to the second signal end of the path selection element for outputting to the transceiver antenna;
a switch comprising an upload input end and an upload output end, wherein the upload input end is coupled to the third signal end of the path selection element, the upload data signal is guided by the path selection element to be output from the third signal end to the switch when the upload data signal is input from the second signal end to the path selection element, and the upload data signal is output from the upload output end when the switch is in a conductive status; and
a control circuit coupled to the detector for controlling the switch to be in an open-circuit status when the detection signal is enabled and controlling the switch to be in the conductive status when the detection signal is disabled.

9. The antenna module as claimed in claim 8, further comprising a delay element allocated in a transmission path between the detector and the path selection element so as to delay the download data signal output by the detector for a delay time, and to further input the download data signal from the first signal end to the path selection element.

10. The antenna module as claimed in claim 9, wherein the delay element is a delay optical fiber.

11. The antenna module as claimed in claim 10, wherein the delay time of the delay optical fiber is greater than a time required for detecting the download data signal by the detector plus a time required by the control circuit for switching the switch to be in the open-circuit status.

12. The antenna module as claimed in claim 8, further comprising:
an optical-to-electrical converter coupled to the base station for receiving the download data signal in an optical signal form and converting the download data signal to be in an electrical signal form;
a power amplifier comprising a power amplifier input end and a power amplifier output end, wherein the power amplifier input end is coupled to the optical-to-electrical converter, and the power amplifier output end is coupled to the detector for amplifying the download data signal in the electrical signal form and transmitting the download data signal to the detector;
a low noise amplifier comprising a low noise amplifier input end and a low noise amplifier output end, wherein the low noise amplifier input end is coupled to the upload output end of the switch for amplifying the upload data signal in the electrical signal form; and
an electrical-to-optical converter coupled with the base station and the low noise amplifier output end for converting the upload data signal in the electrical signal form to be in the optical signal form and transmitting the upload data signal to the base station.

13. The antenna module as claimed in claim 12, wherein the switch is normally conductive so as to enable the upload data signal to be transmitted to the low noise amplifier.

14. The antenna module as claimed in claim 8, wherein the path selection element is a circulator or an optical coupler.

15. The antenna module as claimed in claim 8, wherein the control circuit further waits for a preset time before changing the switch back to be in the conductive status when the detection signal is enabled.

16. A radio over fiber system, comprising:
a switching center;
a head-end cell unit coupled to the switching center; and
a remote antenna end cell unit coupled to the head-end cell unit for transmitting an upload data signal to the switching center through the head-end cell unit or receiving a download data signal from the switching center through the head-end cell unit, wherein the remote antenna end cell unit comprises:
a transceiver antenna transmitting the download data signal through a wireless transmission path or receiving the upload data signal;
a path selection element comprising a first signal end, a second signal end, and a third signal end, wherein the second signal end is coupled to the transceiver antenna;
a detector comprising a detection input end and a detection output end, wherein the detection output end is coupled to the first signal end of the path selection element, and when the detector detects that the detection input end receives the download data signal, activates a detection signal, and transmits the download data signal from the download output end to the first signal end of the path selection element, and guides the download data signal to the second signal end of the path selection element for outputting to the transceiver antenna;
a switch comprising an upload input end and an upload output end, wherein the upload input end is coupled to the third signal end of the path selection element, the upload data signal is guided by the path selection element to be output from the third signal end to the switch when the upload data signal is input from the second signal end to the path selection element, and the upload data signal is output from the upload output end when the switch is in a conductive status; and
a control circuit coupled to the detector for controlling the switch to be in an open-circuit status when the detection signal is enabled and controlling the switch to be in the conductive status when the detection signal is disabled.

17. The radio over fiber system as claimed in claim 16, wherein the remote antenna end cell unit further comprises a delay element allocated in a transmission path between the detector and the path selection element for delaying the download data signal output by the detector for a delay time and further inputting the download data signal from the first signal end to the path selection element.

18. The radio over fiber system as claimed in claim 17, wherein the delay element is a delay optical fiber.

19. The radio over fiber system as claimed in claim 18, wherein the delay time of the delay optical fiber is greater than a time required for detecting the download data signal by the detector plus a time required by the control circuit for switching the switch to be in the open-circuit status.

20. The radio over fiber system as claimed in claim 16, wherein the remote antenna end cell unit further comprises:
a base station coupled to the head-end cell unit;
an optical-to-electrical converter coupled to the base station for receiving the download data signal in an optical signal form and converting the download data signal to be in an electrical signal form;
a power amplifier comprising a power amplifier input end and a power amplifier output end, wherein the power amplifier input end is coupled to the optical-to-electrical converter, and the power amplifier output end is coupled to the detector for amplifying the download data signal in the electrical signal form and transmitting the download data signal to the detector;
a low noise amplifier comprising a low noise amplifier input end and a low noise amplifier output end, wherein the low noise amplifier input end is coupled to the upload output end of the switch for amplifying the upload data signal in the electrical signal form; and
an electrical-to-optical converter coupled with the base station and the low noise amplifier output end for converting the upload data signal in the electrical signal form to be in the optical signal form and transmitting the upload data signal to the base station.

21. The radio over fiber system as claimed in claim 20, wherein the switch is normally conductive so as to enable the upload data signal to be transmitted to the low noise amplifier.

22. The radio over fiber system as claimed in claim 16, wherein the head-end cell unit is coupled to the switching center through either an optical fiber or a coaxial cable.

23. The radio over fiber system as claimed in claim 16, wherein the path selection element is a circulator or an optical coupler.
